(19) United States
(12) Patent Application Publication
(10) Pub. No.: US 2009/0056633 A1
(43) Pub. Date: Mar. 5, 2009

(54) Ant proof pet food & water bowl

(76) Inventors: Thomas L. McDaniel, Cordova, AL (US); Gregory L. McDaniel, Nauvoo, AL (US); Carolyn J. McDaniel, Cordova, AL (US)

Correspondence Address: Thomas L. McDaniel;Tag Products, LLC, 106 Church St., Cordova, AL, 35550, US

(21) Appl. No.: 12/221,784

(22) Filed: Aug. 7, 2008

Related U.S. Application Data
(60) Provisional application No. 60/956,603, filed on Aug. 17, 2007.

(51) Int. Cl. A01K 1/10; A01K 7/00

(52) U.S. Cl. 119/51.5; 119/61.53

(57) ABSTRACT

The ant proof pet food bowl is designed to protect ants from getting into the pets food. It is a dual purpose food and water bowl. The food bowl has a short hollow post (nipple) underneath it. The short hollow post fits into a taller hollow post in the water bowl. This raises the food bowl up over the water bowl and allows the pet to eat and drink from the same bowl without the ants getting the food. Ants do not cross water so they cannot get into the food.

### INVENTION

This invention is an ant proof pet food and water bowl. It is a two tier bowl with the pets water bowl as the lower tier and the pets food bowl as the upper tier. It is both a food and water bowl in one.

### PURPOSE OF INVENTION

This invention will keep ants and other crawling insects from getting into your pets food. A large number of pets leave their food for a period of time and then return to finish eating only to find ants in their food. This bowl will not allow ants to get into the pets food as ants do not cross water.

Other similar inventions attempt to correct this problem by using harsh chemicals or poisonous tape strips. For example, U.S. Pat. No. 4,860,220 and U.S. Pat. No. 4,802,302 both use poisonous tape strips. And U.S. Pat. No. 5,619,952 has a pad with insect repellant. These types of materials could cause tremendous harm to not only the pets but also to the owners. Should your pets or your child or adults come in contact with these poisonous chemicals they could be harmed very badly. Also this invention was made to help owners save money. With this invention their will be no need to continue to buy these by-products to keep your pets food safe from ants. It is completely safe for both pets and owners.

### DESCRIPTION

The food bowl is made to sit on top of the water bowl as shown in FIG. one (1) This is made possible by using the center hollow post made in the water bowl. The food bowl has a nipple shown as No. thirty (30) in FIG. two (2) which sits in the hollow post No. thirty-one (31) In FIG. No. two (2) you can take it apart for easy cleaning. It also helps when the pet leaves food in the bowl and you need to give your pet fresh water. You simply take the food bowl out then rinse out and replace fresh water in the water bowl and replace food bowl.

the bowl is made with the long lasting material of polypropylene. It is approximately 3/16 of an inch thick and is exceptionally strong. The size of the food bowl is seven (7) inches in diameter and three and one half inches (3½) high. The water bowl is twelve (12) inches in diameter and three and one half inches (3½) high. These bowls and made for the medium size pets. The larger bowls for the larger pets are nine (9) inches in diameter and five (5) high for the food and sixteen (16) inches in diameter and five (5) inches high for the water bowl.

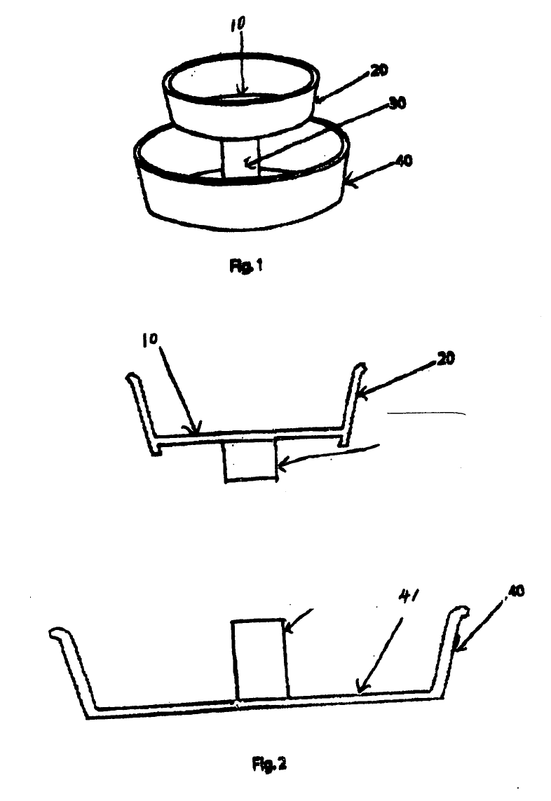

### FIG. 1

10—bottom of food bowl
20—side of food bowl
30—hollow post under food bowl (nipple)
40—side of water bowl

### FIG. 2

10—bottom of food bowl
20—side of food bowl
30—nipple under food bowl
31—hollow post in water bowl
40—side of water bowl
41—bottom of water bowl

1. This bowl is different from other ant proof bowls as it completely free from all foreign substances. It serves as both food and water bowls. It is safe for both pets and owners and is very easy to keep clean.
